(19) United States
(12) Patent Application Publication
(10) Pub. No.: US 2007/0194571 A1
(43) Pub. Date: Aug. 23, 2007

(54) Zero pollution mechanical process and facility for generating electrical energy

(76) Inventors: Eddie K. Wilson SR., Memphis, TN (US); Linda D. Studdard, Ocean Springs, MS (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 11/434,678

(22) Filed: May 16, 2006

Related U.S. Application Data
(60) Provisional application No. 60/776,180, filed on Feb. 23, 2006.

(51) Int. Cl. H02K 7/18; F03G 7/08; F02B 63/04

(52) U.S. Cl. 290/1 R

(57) ABSTRACT

A facility employs a zero pollution mechanical process for generating electrical energy. The facility basically includes at least one electrically powered drive unit, a main shaft that is driven by the drive unit, and an electrical generator powered by the main shaft. Most of the electrical energy generated by the generator is distributed to an electrical grid, though some of it may be diverted to the drive unit to power it.

### CROSS-REFERENCE TO RELATED APPLICATIONS

This application derives and claims priority from U.S. provisional application 60/776,180 of Eddie K. Wilson, Sr., and Linda D. Studdard, filed Feb. 23, 2006.

### STATEMENT REGARDING FEDERALLY SPONSORED RESEARCH

Not Applicable.

### BACKGROUND OF THE INVENTION

This invention relates in general to the production of electrical energy and more particularly to a mechanical process and facility—for generating electrical energy without producing pollution.

Much of the electrical energy used by the United States and other countries, as well, derives from fossil fuels such as coal, oil and natural gas. But as the finite reserves of these fuels are depleted, the fuels become more difficult and expensive to extract, thus increasing the cost of producing electrical energy. Moreover, their use introduces carbon dioxide and, in the case of some fuels, other significant pollutants into the atmosphere, creating harmful conditions, such as smog and perhaps global warming. Other sources of electrical energy have their detractions as well. For example, hydroelectric projects usually include dams, which require huge capital expenditures and inundate land that could otherwise be put to productive uses. Nuclear power plants are also costly and produce radioactive wastes that are not easily or safely disposed. Wind turbines are costly and do not produce significant amounts of energy.

### DESCRIPTION OF THE DRAWINGS

FIG. 1 is a schematic plan view of a facility that employs a zero pollution mechanical process for generating electrical energy, all in accordance with the present invention;

FIG. 2 is a section view taken along line 2-2 of FIG. 1 and showing a hoist- or winch-type drive unit;

FIG. 3 is a perspective view of the drive unit for the facility;

FIG. 4 is a schematic plan view of an alternative facility; and

FIG. 5 is a sectional view taken along line 5-5 of FIG. 4;

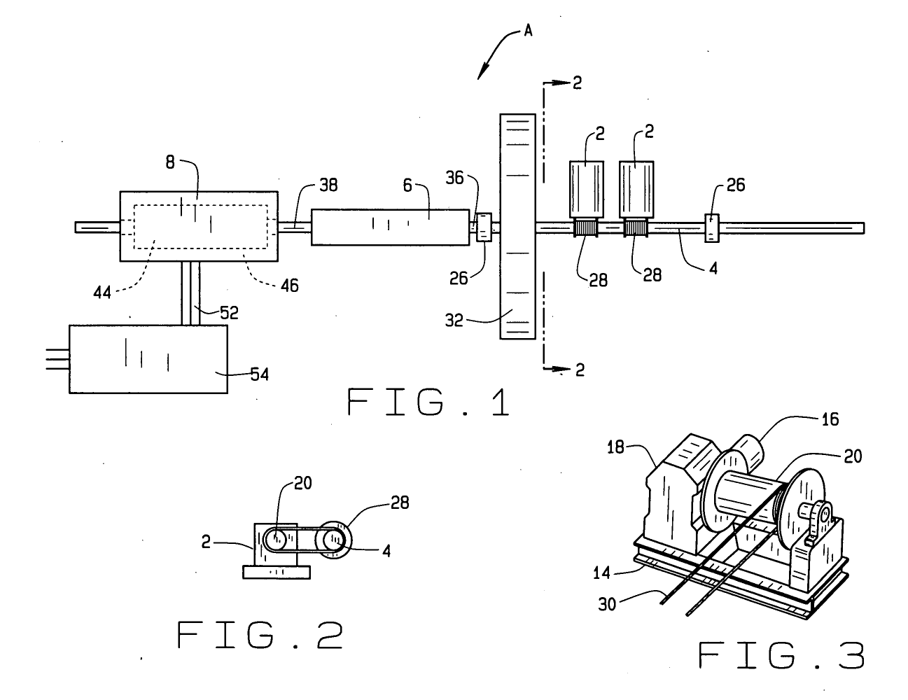

### DETAILED DESCRIPTION OF THE PREFERRED EMBODIMENT

Referring now to the drawings, an electrical generation facility A (FIG. 1) basically includes a drive unit 2, a main shaft 4, a speed increaser gear box 6, and an electrical generator 8. The facility A utilizes mechanical process that generates electrical energy without creating pollution or consuming expensive fuels.

The drive unit 2 takes the form of an electric hoist or winch, and as such has (FIGS. 2 & 3) a base 14, an electric motor 16, a gear box 18, and a drum 20. The gear box 18 is mounted on the base 14 and has an input shaft to which the electric motor 16 is coupled. It also has an output shaft. The drum 20 at one end is connected to the output shaft of the gear box 18 and at its opposite end is supported on a bearing that in turn is supported on the base 14.

The main shaft 4 rotates on bearings 26 that are supported in a fixed position with respect to the drive unit 2. Indeed, it extends along the drive unit 2 with its axis parallel to the axis of the drum 20 for the drive unit 2. It carries a sheave 28 which is secured firmly to it, so that the sheave 28 rotates with the shaft 4 and torque applied to the sheave 28 is transferred to the shaft 4. That torque is exerted through at least one and preferably multiple endless cables 30 that wrap over the sheave 28 and over the drum 20 of the drive unit 2. Preferably each cable 30 has several convolutions around the sheave 28 and several convolutions around the drum 20, so that ample friction develops between the cable 30, on one hand, and the drum 20 and sheave 28, on the other. The drum 20 exerts line pull on the cable 30 and the sheave 28 translates that line pull into rotation of the shaft 4. Thus, the electric motor 16 of the drive unit 2 powers the main shaft 4.

In addition to the sheave 28, the main shaft 4 carries a flywheel 32.

The speed increaser gear box 6 steps up the angular velocity of the main shaft 4 to a velocity suitable for enabling the electrical generator 8 to generate electrical energy at a voltage and frequency acceptable for commercial and residential use. It includes an input shaft 36 and an output shaft 38, the former of which is connected to the main shaft 4 and the latter to the electrical generator 8. Thus, the output shaft 38 rotates at an angular velocity greater than the input shaft 36.

The electrical generator 8 includes a rotor 44 and a stator 46. The rotor 44 is coupled to the output shaft 38 of the speed increaser gear box 6 and thus rotates with the main shaft 4, although at a higher velocity. It revolves within the stator 46, causing an electric potential to develop across coils in the stator 46. When the coils are placed across a load electrical current flows through the stator 46.

That current flows on through electrical lines 52 to an electrical substation 54 that includes transformers, capacitators, and similar equipment, and the substation 54 is in turn connected into an electrical grid. Some of the electrical energy distributed from the substation 54 is diverted to the electric motor 16 of the drive unit 2 to power the drum 20 of that unit 2. However, the motor 16, in the alternative, may be connected to the electrical grid to derive its power from the grid.

In the operation of the generation facility A, the electric motor 16 of the drive unit 2 is initially connected to a source other than the substation 54. That source may be an electrical grid or a stand-alone generator. In any event, the electrical energy from the outside source energizes the motor 16 of the drive unit 2, and the motor 16 turns the drum 20. The drum 20, being connected to the sheave 28 though the endless cable 30 turns the sheave 28 on the main shaft 4. The shaft 4, being secured to the sheave 28, rotates at the velocity of the sheave 28. The shaft 4, acting through the speed increaser gear box 6, rotates the rotor 44 of the electrical generator 8 at an even higher velocity; and the generator 8 produces electrical power in its stator 46. That power is delivered through the lines 52 to the substation 54. Some of it diverted at the substation 54 to the motor 16 of the drive unit 2 and powers the drive unit 2. When the main shaft 4 reaches its normal operating speed, the motor 16 of the drive unit 2 is disconnected from the outside source of electricity and is powered with electrical energy derived from the substation 54.

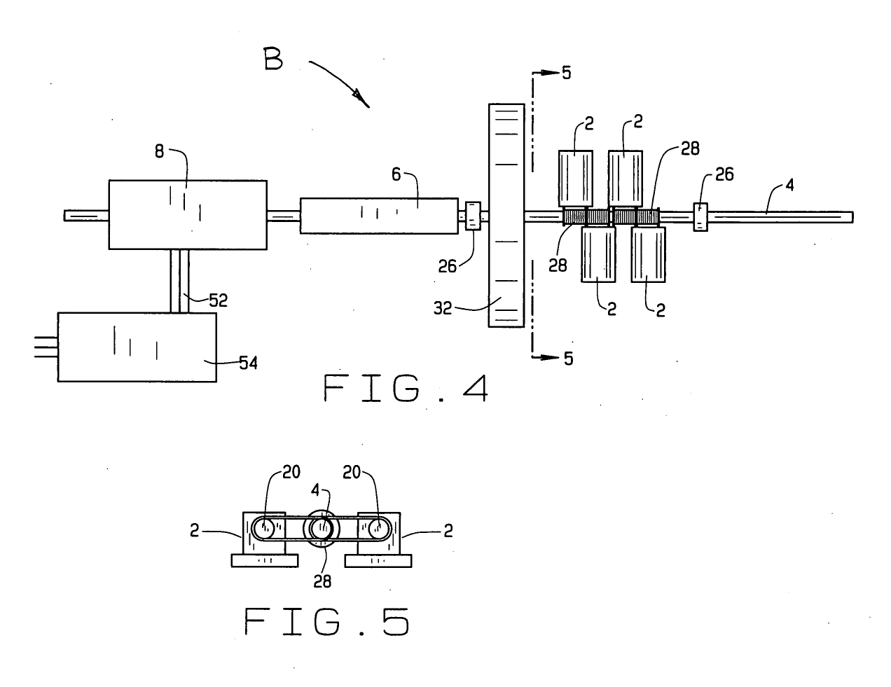

The main shaft 4 may be powered by multiple drive units 2, with the drum 20 of each connected to a different sheave 28 through separate cables 30. Moreover, the shaft 4 may power multiple generators, one connected after the other along the axis of the shaft 4.

Where multiple drive units 2 are employed, they need not all be on the same side of the main shaft 4. Indeed, they may be arranged in a pair or pairs, (FIGS. 4 & 5), with one unit 2 of each pair being on one side of the shaft 4 and the other unit 2 of the pair being on the other side of the shaft 4, but with both units 2 operating through a single sheave 28 and through a single endless cable 30. In this regard, the endless cable 30 winds around the drums 20 of both units 2 and between the units 2 winds around the sheave 28. On the other hand, the two units 2 of the pair may transfer power to the shaft 4 through separate endless cables 30 trained over the same sheave 28 or separate sheaves 28.

Simply stated, the principle upon which the process and facility A rests is the conversion of a force, commonly referred to in the winch and hoist manufacturing industry as line pull, from the straight linear pulling by mechanical means of a line (cable) into an angular or rotating circular motion of a shaft. This is accomplished by placing one or more cables spliced together in a loop, with one end of the loop placed around the drum in the winch and the other end of the loop placed around a sheave that is mounted on the main drive shaft or on a sheave attached to a gear box that is mounted on the main shaft with other components, such as a flywheel, speed increaser gear box and an electric generator.

One or multiple units of multiple sizes (line pull) can be mounted along the main drive shaft to suit the design requirements.

A formula governing the amount of horse power that is produced by various line pull design is:

$$\frac{FORCE ( LINE PULL ) \times RADIUS \times RPM}{63025}$$

In certain designs the flywheel may not be required.

1. A zero pollution mechanical process for generating electricity, said process comprising:
powering a drive unit with electricity;
rotating a main shaft with the drive unit; and
rotating an electrical generator with the main shaft to create electrical power.

2. The process according to claim 1 wherein the drive unit includes at lest one electric motor and a drum driven by the motor; wherein the main shaft carries a sheave; wherein at least one cable extends over the drum and the sheave to transfer power from the drive unit to the main shaft.

3. The process according to claim 2 wherein the electrical generator includes a rotor and a stator, and the main shaft, acting through a speed increaser, turns the rotor at an angular velocity greater than the angular velocity of the main shaft.

4. A process according to claim 1 wherein the electrical power for the electric motor of the drive unit is derived from the generator or from a grid.

5. The process according to claim 1 and further comprising powering another drive unit with electrical power from the generator, and rotating the main shaft with the other drive unit as well.

6. The process according to claim 5 wherein each drive unit includes an electric motor and a drum driven by the motor; wherein the shaft carries a sheave; and wherein at least one cable passes over the sheave and the drums of the drive units to transfer power from the drive units to the shaft.

7. The process according to claim 6 wherein the drive units are on one side or opposite sides of the shaft.

8. A process according to claim 1 wherein the main shaft carries a flywheel.

9. A zero pollution facility for generating electrical power, said facility comprising:
at least one drive unit that is powered by electrical power;
a main shaft coupled to the drive unit such that the drive unit rotates the main shaft; and
an electrical generator connected to the main shaft and rotated by the shaft.

10. A facility according to claim 9 wherein the generator is electrically connected to the drive unit to power the drive unit.

11. A facility according to claim 10 wherein the drive unit comprises an electric motor connected electrically to the generator, and a drum coupled to and driven by the motor.

12. A facility according to claim 11 wherein the shaft carries a sheave, and the drive unit powers the shaft through an at least one endless cable that passes over the drum of the drive unit and the sheave on the shaft.

13. A facility according to claim 12 wherein the electrical generator includes a rotor and a stator; and further comprising a speed increaser gear box located on the main shaft and connected to the rotor of the electrical generator and configured to rotate the rotor at an angular velocity greater than the velocity at which the drive unit rotates the main shaft.

14. A facility according to claim 12 wherein another drive unit is located along the shaft and also has an electrical motor that is electrically connected to the generator; and wherein the cable also passes over the drum of the other drive unit.

15. A zero pollution mechanical process for generating electricity, said process comprising:
developing line pull in a cable;
converting the line pull into rotary motion;
powering a main shaft with the rotary motion;
powering an electrical generator with the main shaft to produce electrical energy; and
distributing electrical energy.

16. A process according to claim 15 wherein the line pull is produced by electrical energy.

17. A process according to claim 16 wherein the electrical energy that produces the line pull is derived from the electrical generator or from a grid.
